(19) United States
(12) Patent Application Publication
(10) Pub. No.: US 2011/0213803 A1
(43) Pub. Date: Sep. 1, 2011

(54) SYSTEM AND METHOD FOR ACCESSING DISTRIBUTED TEMPERATURE SENSING DATA

(76) Inventor: Radoslav (Rado) Mroz, Southampton (GB)

(21) Appl. No.: 13/125,517

(22) PCT Filed: Oct. 23, 2009
(86) PCT No.: PCT/IB2009/054703

§ 371 Date: May 18, 2011

Related U.S. Application Data
(60) Provisional application No. 61/111,407, filed on Nov. 5, 2008.

(51) Int. Cl. G06F 17/30

(52) U.S. Cl. 707/775; 707/E17.016

(57) ABSTRACT

A system operating on one or more computers for accessing sensing data is operable to retrieve time-based measurement data from a system storing the time-based measurement data, display the time-based measurement data in a user interface, and receive an input corresponding to a time of an event of interest in the time-based measurement data. The system is further operable to retrieve sensing data from a sensing system generally corresponding to the time of the event of interest and display the sensing data in the user interface.

This application claims priority from U.S. Provisional Application 61/111,407, filed on Nov. 5, 2008.

### BACKGROUND OF THE INVENTION

1. Field of the Invention

The present invention relates to accessing and visualizing data.

2. Description of Related Art

Distributed temperature sensing (DTS) systems are used in many oilfield installations to determine temperatures at various depths within a well. For example, a DTS system may provide temperature indications at about one meter intervals along a length of a well. One series of measurements may include, for example, hundreds of measurements. Typically, such a series of measurements is made at periodic time intervals, such as, for example, at one minute intervals, one hour intervals, or the like. Measured temperatures are typically displayed for a given point in time as a two-dimensional graph, in which a first axis corresponds to well length and a second axis corresponds to temperature.

Over time, the number of temperature measurement series for a single well may number in the thousands. Choosing which measurement series to display can be a trial and error process. For example, a well may have exhibited a reduced flow rate. It is often desirable to inspect well temperatures to determine if there is a correlation between the reduced flow rate and a change in well temperature. Finding the correct temperature measurement series, however, may take several iterations, considerable time, and considerable computer resources.

There are many systems and methods for accessing data well known in the art; however, considerable shortcomings remain.

### BRIEF SUMMARY OF THE INVENTION

In one aspect, the present invention provides a system operating on one or more computers for accessing DTS data. The system is operable to retrieve data from a supervisory control and data acquisition (SCADA) system, or other system storing time-based measurement data, display the data in a user interface, and receive an input corresponding to a time of an event of interest in the data. The system is further operable to retrieve data from a DTS system generally corresponding to the time of the event of interest and display the DTS data in the user interface.

In another aspect, the present invention provides a method for operating one or more computers for accessing DTS data. The method comprises retrieving data from a SCADA system, or other system storing time-based measurement data, displaying the data in a user interface, and receiving an input corresponding to a time of an event of interest in the data. The method further comprises retrieving data from a DTS system generally corresponding to the time of the event of interest and displaying the DTS data in the user interface.

In yet another aspect, the present invention provides a software for accessing DTS data. The software is embodied in a computer-readable medium and, when executed, is operable to retrieve data from a SCADA system, or other system storing time-based measurement data, display the data in a user interface, and receive an input corresponding to a time of an event of interest in the data. The software, when executed, is further operable to retrieve data from a DTS system generally corresponding to the time of the event of interest and display the DTS data in the user interface.

The present invention provides significant advantages, including: (1) providing a way to link DTS data with time-based sensor data; (2) providing a way to view DTS data for a time period corresponding to an event of interest described in time-based sensor data; and (3) providing a way to view only desired DTS data profiles, without loading all DTS profiles into computer memory before viewing.

Additional objectives, features and advantages will be apparent in the written description which follows.

### BRIEF DESCRIPTION OF THE DRAWINGS

The novel features of the invention are set forth in the appended claims. However, the invention itself, as well as a preferred mode of use, and further objectives and advantages thereof, will best be understood by reference to the following detailed description when read in conjunction with the accompanying drawings, in which the leftmost significant digit in the reference numerals denote the first figure in which the respective reference numeral appears, wherein:

FIG. 1 is a stylized, block diagram depicting an illustrative embodiment of a system for accessing DTS data;

FIGS. 2 and 3 are depictions of an illustrative embodiment of a user interface of the system of FIG. 1;

FIG. 4 is a flowchart depicting an illustrative method of using the system of FIG. 1; and

FIG. 5 is a flowchart depicting an illustrative method of accessing DTS data, which may be performed by the system of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF THE INVENTION

Illustrative embodiments of the invention are described below. In the interest of clarity, not all features of an actual implementation are described in this specification. It will be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention relates to a system for accessing distributed temperature data that is linked to time-based sensor data. In one embodiment, the system accesses a database of a SCADA system, such as a SCADA historian, in which sensor data, such as pressure data, single-point temperature data, flow rate data, or the like, resides. The data of interest is displayed on a user interface, such as a graphical user interface, in tabular and/or graphical forms. The system also accesses a database of a DTS system for temperature data corresponding to a specified sensory event, such as a pressure anomaly, a single-point temperature anomaly, a flow rate anomaly, or the like, represented as data residing in the SCADA system database. For example, when an anomaly is identified in the SCADA system database data, either by computing means or by human means, one or more temperature series from the DTS system database are displayed on the user interface.

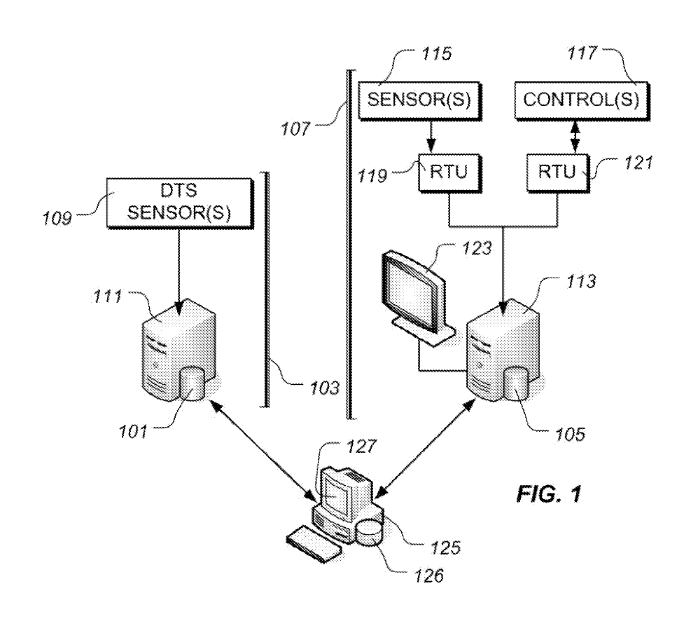

FIG. 1 depicts a stylized, graphical representation of a system for accessing DTS data residing in a database 101 of a DTS system 103 based upon a selected event represented by sensor data residing in a database 105 of a SCADA system 107. DTS data is derived from one or more sensory outputs of a corresponding one or more distributed temperature sensors 109 and database 101. DTS system 103 comprises a DTS system host 111 operably associated with the one or more distributed temperature sensors 109. SCADA system 107 comprises a SCADA host 113 operably associated with one or more sensors 115, such as one or more pressure sensors, one or more single-point temperature sensors, one or more flow rate sensors, or the like, and database 105. In one embodiment, SCADA host 113 is operably associated with one or more controls 117, such as valve controls, pump controls, temperature controls, or the like. The one or more sensors 115 and/or the one or more controls 117 may communicate with SCADA host 113 via other equipment and/or devices, such as remote terminal units 119 and 121, respectively. SCADA system 107 receives inputs from the one or more sensors 115, transforms the inputs into time-based data, and records the data in database 105. SCADA system 107 further includes a human interface, which may be rendered on a display 123 of SCADA host 113. The human interface or a portion thereof may be rendered on other displays, such as a display of combined access computer 125, which is described in greater detail herein. In one embodiment, sensor data residing in database 105 of SCADA system 107 is managed by a SCADA historian residing on SCADA host 113.

Still referring to FIG. 1, combined access computer 125 comprises hardware and software embodied in a computer-readable medium 126, which are embodied in at least combined access computer 125, that access data residing in DTS database 101 and SCADA database 105. Combined access computer 125 includes a user interface 127 that, in the illustrated embodiment, is a graphical user interface. In one embodiment, the combined access computer 125 and the hardware and software embodied in combined access computer 125 access data residing in DTS database 101 and SCADA database 105. In another embodiment, the system for accessing DTS data residing in database 101 of DTS system 103 based upon a selected event represented by sensor data residing in database 105 of SCADA system 107 further comprises one or both of DTS system 103 and SCADA system 107.

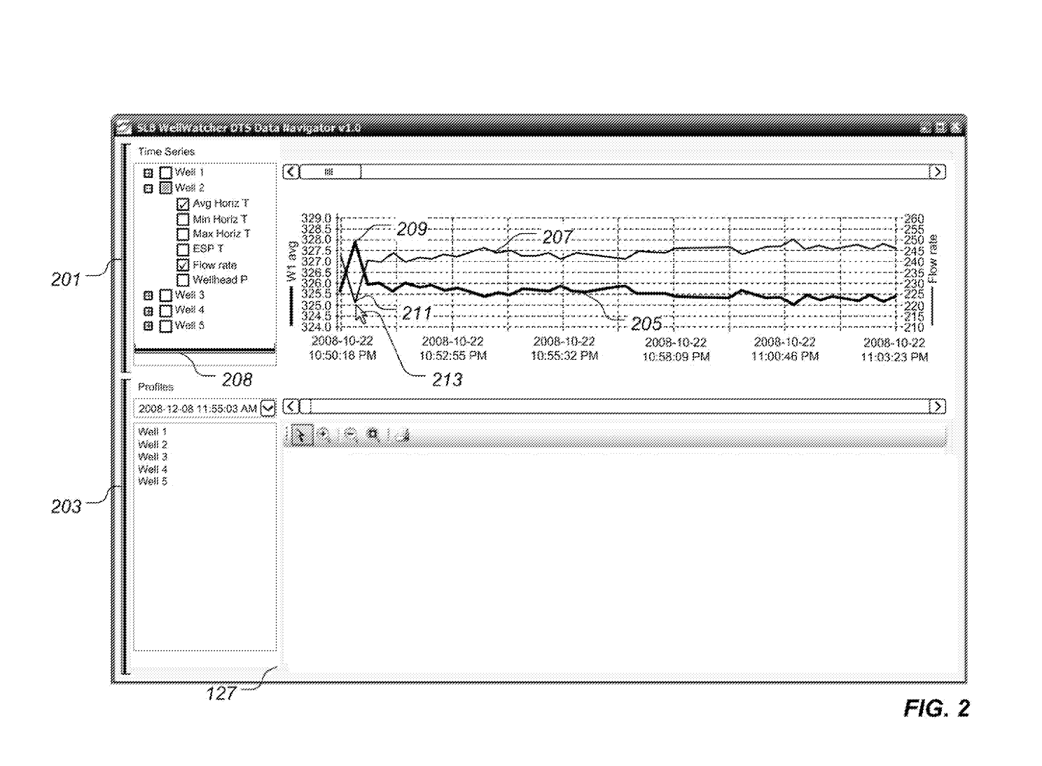

FIG. 2 depicts an exemplary user interface 127. It should be noted that, while user interface 127 is depicted as having a particular configuration in FIG. 2, the scope of the present invention is not so limited. In the embodiment shown in FIG. 2, user interface 127 includes two informational zones, a SCADA or discrete sensor zone 201 and a DTS zone 203. In the view shown in FIG. 2, SCADA data is rendered in zone 201 but no data is rendered in DTS zone 203. While many different types of data from sensors 115, controls 117, (both shown in FIG. 1) or the like may be rendered in SCADA zone 201, “average horizontal temperature,” represented by a line 205, and “flow rate,” represented by a line 207, for “Well 2” are graphically depicted. Various data may be selected for rendering and display in a selection area 208 of user interface 127. SCADA zone 201 further provides gridlines and reference values for the data rendered in zone 201. For example, in the illustrated embodiment, gridlines and reference values are provided in zone 201 for temperature, flow rate, and time, e.g., date and time of day. It should be noted that data for any combination of sensors and/or any combination of wells can be rendered in zone 201. SCADA data is inspected, either by human means or computer means, to find one or more events of interest. For example, FIG. 2 depicts an anomaly in average horizontal temperature, generally at 209, and an anomaly in flow rate, generally at 211. To display DTS data corresponding to a particular time, such as the time at which anomalies 209 and 211 occurred, a pointing device, such as a mouse, tablet pen, or the like, is used to place a pointer 213 at the time of interest and the pointing device is actuated.

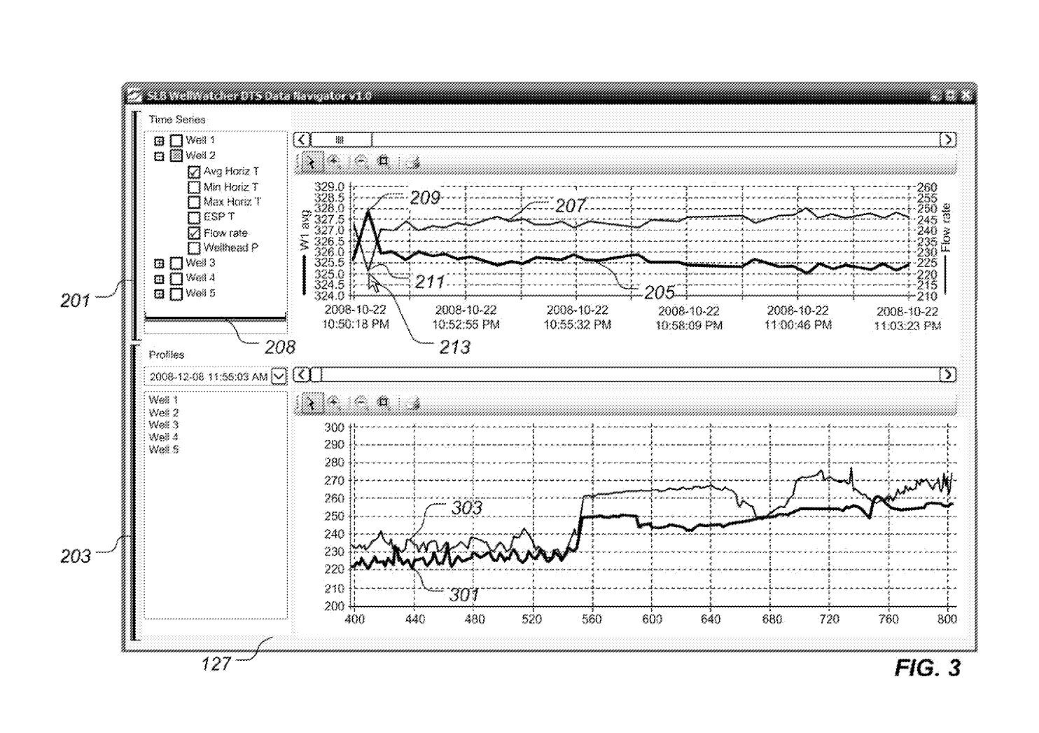

FIG. 3 additionally depicts an exemplary embodiment of the results rendered in DTS zone 203 of user interface 127 upon entering the time of interest in SCADA zone 201. In the embodiment illustrated in FIG. 3, DTS data from one or more times generally corresponding to the time and wells selected in SCADA zone 201 are displayed. For example, data for a time prior to the time selected in SCADA zone 201 is graphically displayed as line 301, while data for a time after the time selected in SCADA zone 201 is graphically displayed as line 303. DTS zone 203 further provides gridlines and reference values for the data rendered in zone 203. Thus, for one or more times generally corresponding to a particular time of interest, determined from SCADA data, data from one or more distributed temperature sensing runs can readily be rendered.

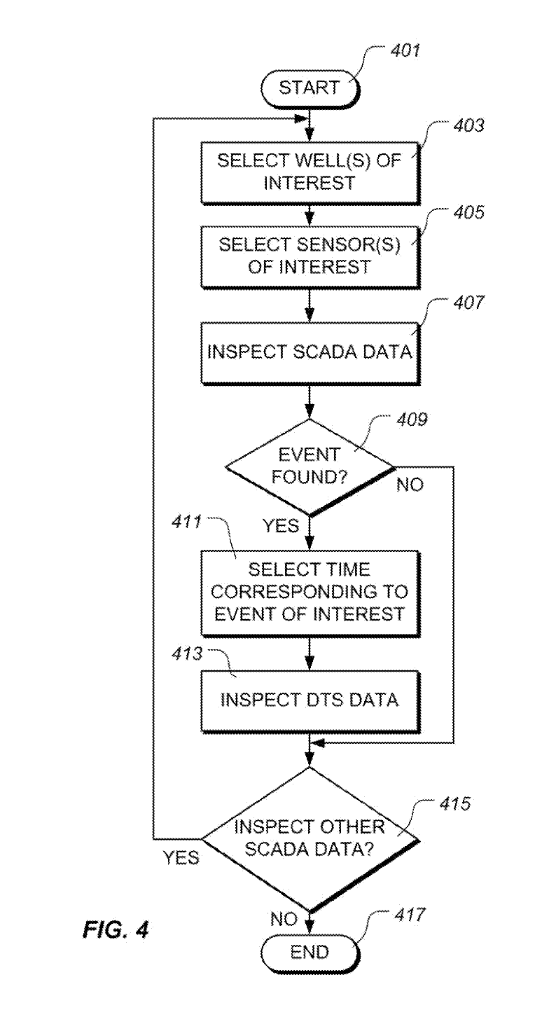

FIG. 4 provides a flowchart depicting an illustrative embodiment of a method for using the system of FIG. 1. In the illustrated embodiment, the method starts at block 401. The operator of the method selects one or more wells of interest (block 403), such as in selection area 208 of SCADA zone 201 in user interface 127 (each shown in FIG. 2). One or more sensors of interest are selected (block 405), such as in selection area 208. The SCADA data for the selected one or more wells and the one or more sensors is rendered and displayed, such as in SCADA zone 201, by the system and inspected to determine events of interest (block 407). If an event is found (block 409), the time corresponding to the event is selected (block 411). DTS data corresponding to the selected time is rendered and displayed, such as in DTS zone 203, by the system and inspected (block 413). It should be noted that DTS data for a plurality of times that fall about the selected time may be rendered and displayed. If no event is found in the SCADA data (block 409) and/or after the DTS data has been inspected (block 413), a determination is made whether to inspect other SCADA data (block 415). If an inspection of other SCADA data is desired, the method restarts at block 403 to select one or more wells of interest. If no other inspection of SCADA data is desired, the method ends at block 417.

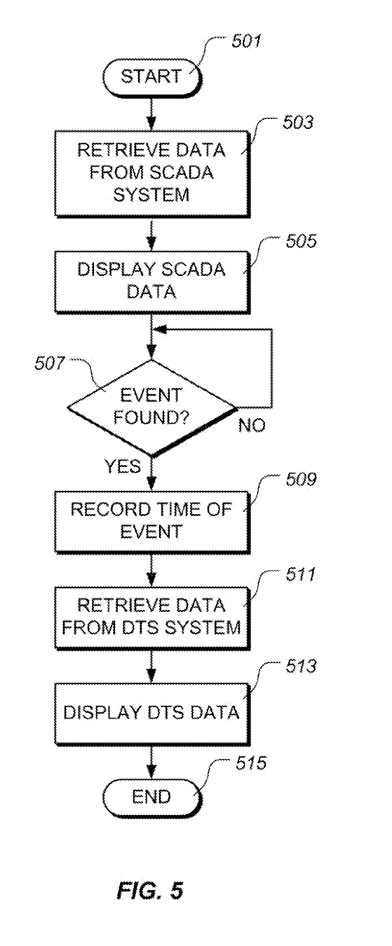

FIG. 5 provides a flowchart depicting an illustrative embodiment of a method for accessing DTS data that may be performed using the system of FIG. 1. In the illustrated embodiment, the method starts at block 501. Based upon the one or more wells and the one or more sensors selected, such as in blocks 403 and 405 of the method shown in FIG. 4, sensor data is retrieved from SCADA system 107 (block 503). The retrieved SCADA data is rendered and displayed in graphical and/or textual forms (block 505). When an event of interest is found (block 507), such as in block 409 of the method shown in FIG. 4, and the time corresponding to the event is selected, such as in block 411 of the method shown in FIG. 4, a record is made of the time of the event of interest (block 509). Data corresponding to the time of the event of interest is retrieved from DTS system 103 (block 511), rendered, and displayed (block 513). It should be noted that DTS data for a plurality of times that fall about the selected time may be rendered and displayed. The method ends at block 515.

While the present invention is described herein as being operatively associated with one or more wells, the scope of the present invention is not so limited. Rather, the present invention contemplates the present system being a part of many different types of implementations.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Although the present invention is shown in a limited number of forms, it is not limited to just these forms, but is amenable to various changes and modifications without departing from the spirit thereof.

1. A system operating on one or more computers for accessing sensing data, the system operable to:
retrieve time-based measurement data from a system storing the time-based measurement data;
display the time-based measurement data in a user interface;
receive an input corresponding to a time of an event of interest in the time-based measurement data;
retrieve sensing data from a sensing system generally corresponding to the time of the event of interest; and
display the sensing data in the user interlace.

2. The system of claim 1, wherein:
the system storing the time-based measurement data is a SCADA system; and
the sensing system is a distributed temperature sensing (DTS) system.

3. The system of claim 2, wherein the sensing data retrieved from the DTS system comprises:
a first data series corresponding to a time prior to the time of the event of interest; and
a second data series corresponding to a time after the time of the event of interest.

4. The system of claim 2, wherein the system is capable of retrieving time-based measurement data from the SCADA system corresponding to one or more wells.

5. The system of claim 2, wherein the system is capable of retrieving time-based measurement data from the SCADA system corresponding to one or more sensors.

6. The system of claim 2, wherein the SCADA time-based measurement data is displayed in a graphical form.

7. The system of claim 2, wherein the input corresponding to the time of the event of interest is generated by a pointing device.

8. A method for operating one or more computers for accessing sensing data, comprising:
retrieving time-based measurement data from a system storing the time-based measurement data;
displaying the time-based measurement data in a user interface;
receiving an input corresponding to a time of an event of interest in the time-based measurement data;
retrieving sensing data from a sensing system generally corresponding to the time of the event of interest; and
displaying the sensing data in the user interface.

9. The method of claim 8, wherein:
the system storing the time-based measurement data is a SCADA system; and
the sensing system is a distributed temperature sensing (DTS) system.

10. The method of claim 9, wherein retrieving sensing data from the DTS system is accomplished by:
retrieving a first data series corresponding to a time prior to the time of the event of interest; and
retrieving a second data series corresponding to a time after the time of the event of interest.

11. The method of claim 9, wherein retrieving time-based measurement data from the SCADA system is accomplished by retrieving time-based measurement data from the SCADA system corresponding to one or more wells.

12. The method of claim 9, wherein retrieving time-based measurement data from the SCADA system is accomplished by retrieving time-based measurement data from the SCADA system corresponding to one or more sensors.

13. The method of claim 9, wherein displaying the SCADA time-based measurement data in the user interface is accomplished by displaying the SCADA time-based measurement data in a graphical form.

14. The method of claim 9, wherein receiving the input corresponding to the time of the event of interest is accomplished by receiving an input from a pointing device.

15. The method of claim 14, further comprising:
directing a pointing device to a location in the user interface proximate a representation of the event of interest; and
actuating the pointing device to generate the input corresponding to the time of the event of interest.

16. The method of claim 9, further comprising inspecting the displayed SCADA time-based measurement data to determine the event of interest.

17. The method of claim 9, further comprising inspecting the displayed DTS data.

18. Software for accessing sensing data, the software embodied in a computer-readable medium and when executed operable to:
retrieve time-based measurement data from a system storing the time-based measurement data;
display the time-based measurement data in a user interface;
receive an input corresponding to a time of an event of interest in the time-based measurement data;
retrieve sensing data from a sensing system generally corresponding to the time of the event of interest; and
display the sensing data in the user interface.

19. The software of claim 18, wherein:
the system storing the time-based measurement data is a SCADA system; and
the sensing system is a distributed temperature sensing (DTS) system.

20. The software of claim 19, wherein the sensing data retrieved from the DTS system comprises:
a first data series corresponding to a time prior to the time of the event of interest; and
a second data series corresponding to a time after the time of the event of interest.

21. The software of claim 19, wherein the software, when executed, is capable of retrieving time-based measurement data from the SCADA system corresponding to one or more wells.

22. The software of claim 19, wherein the software, when executed, is capable of retrieving time-based measurement data from the SCADA system corresponding to one or more sensors.

23. The software of claim 19, wherein the SCADA time-based measurement data is displayed in a graphical form.

24. The software of claim 18, wherein the input corresponding to the time of the event of interest is generated by a pointing device.

25. A system for accessing and displaying downhole sensor data, the system operable to:
store time-based data from multiple or distributed downhole sensors installed in a wellbore;
monitor measurements from a supervisory control and data acquisition (SCADA) system;
receive an input corresponding to an event of interest in the monitored measurements;
retrieve a first data series from the stored data, wherein the first data series corresponds to a first interval of time before the event of interest;
retrieve a second data series from the stored data, wherein the second data series corresponds to a second interval of time after the event of interest; and
display in graphical form the first and second data series on a user interface.

26. The system of claim 25 wherein the graphical display incorporates elements of the first and second data series and data from the SCADA system.

27. The system of claim 25 wherein the input is the time of an event of interest in the monitored measurements identified by a pointing device.

28. A method for identifying, accessing and displaying downhole sensor data, comprising the steps of:
storing in a first storage device time-based data from multiple or distributed downhole sensors installed in a wellbore;
retrieving measurements from a supervisory control and data acquisition (SCADA) system;
identifying an event of interest in the retrieved measurements;
retrieving a first data series from the first storage device, wherein the first data series corresponds to a first interval of time before the event of interest;
retrieving a second data series from the first storage device, wherein the second data series corresponds to a second interval of time after the event of interest; and
displaying in graphical form the first and second data series on a user interface.

29. The method of claim 28 wherein the identification of the event of interest is performed by activation of a pointing device on a graphical display of the SCADA system measurements.
